(19) United States
(12) Patent Application Publication
(10) Pub. No.: US 2022/0345268 A1
(43) Pub. Date: Oct. 27, 2022

(54) TERMINAL AND RADIO COMMUNICATION METHOD

(71) Applicant: NTT DOCOMO, INC., Tokyo (JP)

(72) Inventors: Yuki Matsumura, Tokyo (JP); Hiroki Harada, Tokyo (JP); Satoshi Nagata, Tokyo (JP)

(73) Assignee: NTT DOCOMO, INC., Tokyo (JP)

(21) Appl. No.: 17/754,441

(22) PCT Filed: Oct. 4, 2019
(86) PCT No.: PCT/JP2019/039391

§ 371 Date: Apr. 1, 2022

(51) Int. Cl. H04L 5/00; H04L 1/00

(52) U.S. Cl. CPC H04L 5/0048; H04L 5/0053; H04L 1/0013

(57) ABSTRACT

A terminal according to an aspect of the present disclosure includes: a receiving section configured to, when a physical downlink shared channel (PDSCH) and a specific downlink signal overlap each other in at least one symbol, and a first reference signal of quasi-co-location (QCL) type D of the PDSCH is different from a second reference signal of the QCL type D of the specific downlink signal, receive a signal of at least one of the PDSCH and the specific downlink signal by using the second reference signal in the at least one symbol; and a control section configured to perform at least one of decoding and measurement of the received signal. According to an aspect of the present disclosure, a plurality of DL signals having different QCL parameters can be appropriately processed.

### TECHNICAL FIELD

The present disclosure relates to a terminal and a radio communication method in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (e.g., referred to as “5th generation mobile communication system (5G),” “5G+ (plus),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, NR), the following has been under study: a user terminal (terminal, user terminal, User Equipment (UE)) controls transmission and reception processing, based on information related to quasi-co-location (QCL).

However, operation when a plurality of DL signals using different QCL parameters overlap each other is not made clear. Unless appropriate operation is performed, system performance may be deteriorated.

In view of this, one object of the present disclosure is to provide a terminal and a radio communication method that enable appropriate processing of a plurality of DL signals having different QCL parameters.

### Solution to Problem

A terminal according to an aspect of the present disclosure includes: a receiving section configured to, when a physical downlink shared channel (PDSCH) and a specific downlink signal overlap each other in at least one symbol, and a first reference signal of quasi-co-location (QCL) type D of the PDSCH is different from a second reference signal of the QCL type D of the specific downlink signal, receive a signal of at least one of the PDSCH and the specific downlink signal by using the second reference signal in the at least one symbol; and a control section configured to perform at least one of decoding and measurement of the received signal.

### Advantageous Effects of Invention

According to an aspect of the present disclosure, a plurality of DL signals having different QCL parameters can be appropriately processed.

### BRIEF DESCRIPTION OF DRAWINGS

FIG. 1 is a diagram to show an example of QCL assumption PDSCH;

FIG. 2 is a diagram to show an example of reception processing 1;

FIG. 3 is a diagram to show an example of reception processing 2;

FIG. 4 is a diagram to show an example of reception of a plurality of DMRSs using different beams;

FIG. 5 is a diagram to show an example of beam switch;

FIG. 6 is a diagram to show an example of plurality of receptions of the PDSCH;

FIG. 7 is a diagram to show an example of a schematic structure of a radio communication system according to one embodiment;

FIG. 8 is a diagram to show an example of a structure of a base station a cording to one embodiment;

FIG. 9 is a diagram to show an example of a structure of a user terminal according to one embodiment; and

FIG. 10 is a diagram to show an example of a hardware structure of the base station and the user terminal according to one embodiment.

### DESCRIPTION OF EMBODIMENTS

### (TCI, QCL)

In NR, there has been study conducted in regard to control of reception processing (for example, at least one of reception, demapping, demodulation, and decoding), transmission processing (for example, at least one of transmission, mapping, precoding, modulation, and coding), and the like of at least one of a signal and a channel (which may be referred to as “signal/channel”; in the present disclosure, “A/B” may be similarly interpreted as “at least one of A and B”) in a UE, based on a transmission configuration indication state (TCI state).

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a given signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter (s) (which may be referred to as QCL parameter(s)) are described below:
QCL type A: Doppler shift, Doppler spread, average delay, and delay spread
QCL type B: Doppler shift and Doppler spread
QCL type C: Doppler shift and Average delay
QCL type D: Spatial reception parameter

Types A to C may correspond to QCL information related to synchronization processing of at least one of time and frequency, and type D may correspond to QCL information related to beam control.

A case that the UE assumes that a given control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (or a reference signal (RS) for the channel) and another signal (for example, another downlink reference signal (DL-RS)). The TCI state may be configured (indicated) by higher layer signaling or physical layer signaling, or a combination of these.

In the present disclosure, for example, the higher layer signaling may be any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

Note that the channel/signal as a target of application of the TCI state may be referred to as a target channel/RS, or simply as a target or the like, and such another signal may be referred to as a reference RS, or simply as a reference or the like.

A channel for which the TCI state is configured (indicated) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS (DL-RS) to have a QCL relationship with the channel may be, for example, at least one of a synchronization signal block (SSB), a channel state information reference signal (CSI-RS), and a reference signal for measurement (Sounding Reference Signal (SRS)). Alternatively, the DL-RS may be a CSI-RS used for tracking (also referred to as a Tracking Reference Signal (TRS)), or a reference signal used for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An information element of the TCI state (“TCI-state IE” of RRC) configured using higher layer signaling may include one or a plurality of pieces of QCL information (“QCL-Info”). The QCL information may include at least one of information related to the DL-RS to have a QCL relationship (DL-RS relation information) and information indicating a QCL type (QCL type information). The DL-RS relation information may include information such as an index of the DL-RS (for example, an SSB index, or a non-zero power CSI-RS (NZP CSI-RS) resource ID (Identifier)), an index of a cell in which the RS is located, and an index of a Bandwidth Part (BWP) in which the RS is located.

### <TCI State for PDCCH>

Information related to the QCL between the PDCCH (or a DMRS antenna port related to the PDCCH) and a given DL-RS may be referred to as a TCI state for the PDCCH or the like.

The UE may determine the TCI state for a UE-specific PDCCH (CORESET), based on higher layer signaling. For example, one or a plurality (K) of TCI states may be configured for the UE for each CORESET by using RRC signaling (ControlResourceSet information element).

Regarding each CORESET, one or a plurality of TCI states may each be activated using the MAC CE. The MAC CE may be referred to as a TCI state indication MAC CE for the UE-specific PDCCH (TCI State Indication for UE-specific PDCCH MAC CE). The UE may perform monitoring of the CORESET, based on the active TCI state corresponding to the CORESET.

<TCI State for PDSCH>

Information related to the QCL between the PDSCH (or a DMRS antenna port related to the PDSCH) and a given DL-RS may be referred to as a TCI state for the PDSCH or the like.

M (M≥1) TCI states for the PDSCH (M pieces of QCL information for the PDSCH) may be notified for (configured for) the UE by using the higher layer signaling. Note that the number M of TCI states configured for the UE may be limited by at least one of UE capability and a QCL type.

The DCI used for scheduling of the PDSCH may include a given field indicating the TCI state for the PDSCH (which may be referred to as, for example, a TCI field, a TCI state field, or the like). The DCI may be used for scheduling of the PDSCH of one cell, and may be referred to as, for example, DL DCI, DL assignment, DCI format 1_0, DCI format 1_1, or the like.

Whether or not the TCI field is included in the DCI may be controlled by using information notified from the base station to the UE. The information may be information (for example, TCI presence information, TCI presence information in DCI, a higher layer parameter TCI-PresentInDCI) indicating whether the TCI field is present or not (present or absent) in the DCI. The information may be, for example, configured for the UE by using the higher layer signaling.

When more than eight types of TCI states are configured for the UE, eight or less types of TCI states may be activated (or specified) by using the MAC CE. The MAC CE may be referred to as a TCI state activation/deactivation MAC CE for the UE-specific PDSCH (TCI States Activation/Deactivation for UE-specific PDSCH MAC CE). The value of the TCI field in the DCI may indicate one of the TCI states activated by using the MAC CE.

When the TCI presence information set as “enabled” is configured for the UE for the CORESET for scheduling the PDSCH (CORESET used for PDCCH transmission for scheduling the PDSCH), the UE may assume that the TCI field is present in DCI format 1_1 of the PDCCH transmitted on the CORESET.

In a case where the TCI presence information is not configured for the CORESET for scheduling the PDSCH, or the PDSCH is scheduled by DCI format 1_0, when a time offset between reception of the DL DCI (DCI for scheduling the PDSCH) and reception of the PDSCH corresponding to the DCI is equal to or larger than a threshold, in order to determine the QCL of a PDSCH antenna port, the UE may assume that the TCI state or the QCL assumption for the PDSCH is the same as the TCI state or the QCL assumption applied to the CORESET used for PDCCH transmission for scheduling the PDSCH.

In a case where the TCI presence information is set as “enabled”, when the TCI field in the DCI in a component carrier (CC) for scheduling (the PDSCH) indicates an activated TCI state in the scheduled CC or the DL BWP, and the PDSCH is scheduled by DCI format 1_1, in order to determine the QCL of the PDSCH antenna port, the UE may use the TCI in accordance with the value of the TCI field in the detected PDCCH having the DCI. When the time offset between reception of the DL DCI (for scheduling the PDSCH) and the PDSCH corresponding to the DCI (PDSCH scheduled by the DCI) is equal to or larger than the threshold, the UE may assume that the DM-RS port of the PDSCH of the serving cell is quasi co-located with the RS in the TCI state related to a QCL type parameter given by the indicated TCI state.

When a single slot PDSCH is configured for the UE, the indicated TCI state may be based on the activated TCI state in the slot having the scheduled PDSCH. When a plurality of slot PDSCHs are configured for the UE, the indicated TCI state may be based on the activated TCI state in the first slot having the scheduled PDSCH, and the UE may expect that the TCI state is the same over the slots having the scheduled PDSCH. When the CORESET associated with the search space set for cross carrier scheduling is configured for the UE, the TCI presence information is set to “enabled” for the UE for the CORESET, and when at least one of the TCI states configured for the serving cell scheduled by the search space set includes QCL type D, the UE may assume that the time offset between a detected PDCCH and the PDSCH corresponding to the PDCCH is equal to or larger than the threshold.

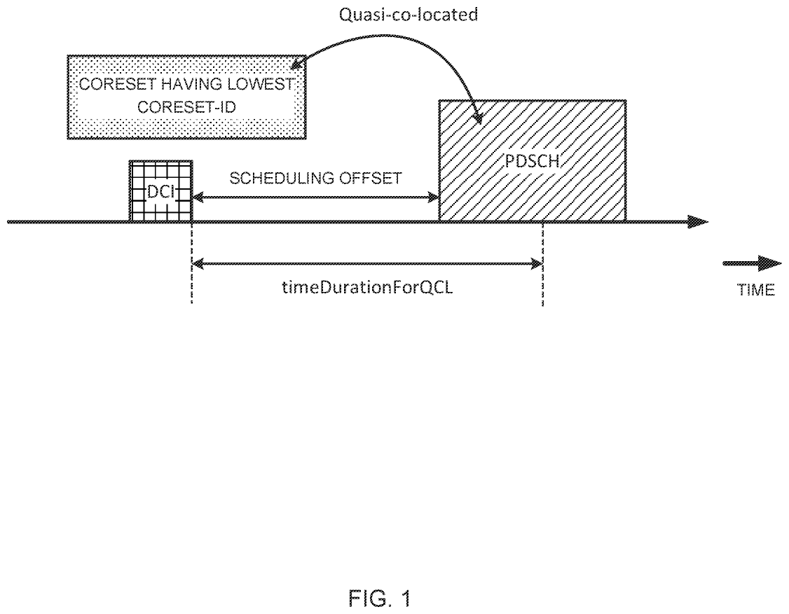

In both of the case where the TCI information in DCI (higher layer parameter TCI-PresentInDCI) is set to “enabled” and the case where the TCI information in DCI is not configured in an PEC connection mode, when the time offset between reception of the DL DCI (DCI for scheduling the PDSCH) and its corresponding PDSCH (PDSCH scheduled by the DCI) is less than the threshold, the UE may assume that the DM-RS port of the PDSCH of the serving cell has the minimum (lowest) CORESET-ID in the latest (most recent) slot in which one or more CORESETs in the active BWP of the serving cell are monitored by the UE, and is quasi co-located with the RS related to the QCL parameter used for QCL indication of the PDCCH of the CORESET associated with the monitored search space (FIG. 1). The RS may be referred to as a default TCI state of the PDSCH.

The time offset between the reception of the DL DCI and the reception of the PDSCH corresponding to the DCI may be referred to as a scheduling offset.

The threshold may be referred to as a time length for QCL, a time length threshold for QCL, a “timeDurationForQCL”, a “Threshold”, a “Threshold for offset between a DCI indicating a TCI state and a PDSCH scheduled by the DCI”, a “Threshold-Sched-Offset”, a schedule offset threshold, a scheduling offset threshold, or the like.

The time length threshold for QCL may be based on the UE capability, and may be, for example, based on a delay that is required for decoding of the PDCCH and beam switch. Information of the time length threshold for QCL may be configured by the base station by using the higher layer signaling, or may be transmitted from the UE to the base station.

For example, the UE may assume that the DMRS port of the PDSCH is quasi co-located with the DL-RS that is based on the TCI state activated for the CORESET corresponding to the minimum CORESET-ID. The latest slot may be, for example, a slot in which the DCI for scheduling the PDSCH is received.

Note that the CORESET-ID may be an ID configured by using the RRC information element “ControlResourceSet” (ID for identification of the CORESET).

(Overlap of Plurality of DL Signals Having Different QCL Parameters)

In a case where the default TCI state is applied to the PDSCH, if a PDSCH DMRS and a PDCCH DMRS overlap each other in at least one symbol, and QCL type D of the PDSCH DMRS (RS of QCL type D) and the QCL type P of the POOCH DMRS (RS of QCL type D) are different, the UE expects to prioritize reception of the PDCCH associated with the CORESET used for the default TCI state. This is also applied to an intra-band CA case (case in which the PDSCH and the CORESET are in different component carriers (CCs)).

The following case is considered: also for the UE having a single active TCI state, the PDSCH and the CSI-RS or the SSE that do not have a QCL-D relationship with each other (that are not of QCL-D, or that have RSs of different QCL type Ds) are scheduled.

### EXAMPLE 1

Also for the UE having a single active TCI state, it is assumed that an NW configures resources (for example, 64 P-TRS resources) of a plurality of periodic (P)-TRSs (for example, 64 P-TRSs) for the UE. In this case, it is assumed that the NW transmits the plurality of P-TRSs. It is considered that one of the TRSs overlaps with the PDSCH not having a QCL-D relationship with each other. A UE reception operation in this case is not defined in Rel. 15.

### EXAMPLE 2

Also for the UE having a single active TCI state, a plurality of resources of the CSI-RS or the SSE for beam measurement (for example, L1-RSRP report) can be configured for the UE. It is considered that one of the CSI-RS and the SSE overlaps with the PDSCH not in a QCL-D relationship with each other. A UE reception operation in this case is not defined in Rel. 15.

The following has been under study: in a case where the default TCI state is applied to the PDSCH, if the PDSCH DMRS and the CSI-RS overlap each other in at least one symbol, and QCL type D of the PDSCH DMRS is different from QCL type P of the CSI-RS, the UE expects to prioritize reception of the CSI-RS. The CSI-RS may be any one of a periodic CSI-RS (P-CSI-RS), a semi-persistent (SP-CSI-RS), and an aperiodic CSI-RS (A-CSI-RS) scheduled (triggered) by the PDCCH having an offset of equal to or larger than an A-CSI-RS beam switch timing threshold (beamSwitchTiming, {4 symbols, 28 symbols, 48 symbols}) reported by the UE. The A-CSI-RS beam switch timing threshold is minimum time between the DCI for triggering the A-CSI-RS and A-CSI-RS transmission, and is the number of symbols measured from the last symbol of the DCI to the first symbol of the A-CSI-RS.

However, the operation of the UE when the CSI-RS and the PDSCH overlap each other in at least one symbol is not made clear. Unless the operation is made clear, system performance may be deteriorated, such as deterioration of performance of reception of the PDSCH and deterioration of accuracy of measurement of the CSI.

In view of this, the inventors of the present invention came up with the idea of operation in a case where the PDSCH overlaps with another DL signal using a parameter of different QCL type D in a time resource.

Embodiments according to the present disclosure will be described in detail below with reference to the drawings. A radio communication method according to each embodiment may be individually applied, or may be applied in combination.

A TCI state, QCL assumption, a QCL parameter, a TCI state or QCL assumption, a spatial domain reception filter, a UE spatial domain reception filter, a spatial domain filter, a UE receive beam, a DL receive beam, a DL-RS, a parameter of QCL type D, an RS of QCL type D, a DL-RS associated with QCL type D, a DL-RS having QCL type D, a source of a DL-RS, an SSB, and a CSI-RS may be interchangeably interpreted as each other.

In the present disclosure, the TCI state may be information (for example, the DL-RS, the QCL type, a cell in which the DL-RS is transmitted, or the like) related to a receive beam (spatial domain reception filter) indicated (configured) for the UE. The QCL assumption may be information (for example, the DL-RS, the QCL type, a cell in which the DL-RS is transmitted, or the like) related to a receive beam (spatial domain reception filter) that is assumed by the UE, based on transmission or reception of an associated signal (for example, the PRACH).

In the present disclosure, a cell, a CC, a carrier, a BWP, and a band may be interchangeably interpreted as each other.

In the present disclosure, an index, an ID, an indicator, and a resource ID may be interchangeably interpreted as each other.

In the present disclosure, a specific UL signal, specific UL transmission, a specific UL channel, a specific type of UL transmission, a PUSCH, a PUCCH, and an SRS may be interchangeably interpreted as each other.

In the present disclosure, a specific DL signal, specific DL reception, specific DL transmission, a specific DL channel, a specific downlink signal, a specific type of DL reception, a PDSCH, a PDCCH, a CORESET, a DL-RS, an SSE, a CSI-RS, a TRS, and a CSI-RS for tracking may be interchangeably interpreted as each other.

In the present disclosure, the latest slot and the most recent slot may be interchangeably interpreted as each other.

In the present disclosure, “a DL signal a and a DL signal b are not quasi co-located”, “the DL signal a and the DL signal b are not in a QCL type D relationship”, “the RS of QCL type D of the DL signal a and the RS of QCL type D of the DL signal b are different”, “the QCL parameter of the DL signal a and the QCL parameter of the DL signal b are different”, and “QCL type D of the DL signal a and QCL type ID of the DL signal b are different” may be interchangeably interpreted as each other.

(Radio Communication Method)

A target case may be a case in which the PDSCH and a specific DL signal overlap each other in at least one symbol, and the RS of QCL type D of the PDSCH is different from the RS of QCL type D of the specific DL signal. In the target case, the UE may receive at least one of the specific DL signal and the PDSCH by using the RS of QCL type D of at least one of the specific DL signal and the PDSCH.

In the present disclosure, “the DL signal a and the DL signal b overlap each other” and “the DL signal a and the DL signal b are simultaneously received” may be interchangeably interpreted as each other. In the embodiment, simultaneous reception of the PDSCH and the specific DL signal is described; however, similarly, the embodiment may also be applied to simultaneous reception of the PDCCH and the specific DL signal. In other words, in the present disclosure, the PDSCH and the PDCCH may be interchangeably interpreted as each other.

The specific DL signal may be a CSI-RS, or may be an SSB.

The CSI-RS may be any one of a P-CSI-RS, an SP-CSI-RS, and an A-CSI-RS scheduled by the PDCCH having an offset of equal to or larger than an A-CSI-RS beam switch timing threshold ({4 symbols, 28 symbols, 48 symbols}) reported by the UE. The PDSCH and the CSI-RS may be present in the same CC, or may present in different CCs in the same band.

The target case may be a case in which the PDSCH time offset is equal to or larger than the time length threshold for QCL, the PDSCH and the specific DL signal overlap each other in at least one symbol, and the RS of QCL type D of the PDSCH is different from the RS of QCL type D of the specific DL signal.

### First Embodiment

In the target case, the UE may receive the specific DL signal, or may receive at least one of the PDSCH and the CSI-RS by using the RS of QCL type D of the specific DL signal.

The specific DL signal may be a CSI-RS. The target case may be a case in which the PDSCH and the CSI-RS overlap each other in at least one symbol, and the RS of QCL type D of the PDSCH is different from the RS of QCL type D of the CSI-RS.

In the target case, the UE may measure the CSI-RS, or may receive at least one of the PDSCH and the CSI-RS by using the RS of QCL type D of the CSI-RS.

The target case may be a case in which the PDSCH time offset is equal to or larger than the time length threshold for CCL, the PDSCH and the CSI-RS overlap each other in at least one symbol, and the RS of QCL type D of the PDSCH is different from the RS of QCL type D of the CSI-RS.

### <<Operation>>

In the target case, the UE may measure the CSI-RS, or may use the RS of QCL type D of the CSI-RS.

In this case, the UE may perform any one of the following reception processings 1 and 2.

### [Reception Processing 1]

In a symbol (overlap symbol) in which the PDSCH and the CSI-RS overlap each other, the UE may measure the CSI-RS by using the RS of QCL type D of the CSI-RS, and need not perform reception (demodulation, decoding) of the PDSCH. The UE may assume that the PDSCH is punctured or dropped in the overlap symbol, and may perform demodulation and decoding of the PDSCH by using the RS of QCL type D of the PDSCH in a symbol (non-overlap symbol) that is not the overlap symbol.

When a coding rate of the PDSCH is lower than a given value (or equal to or lower than the given value), reception processing 1 may be used.

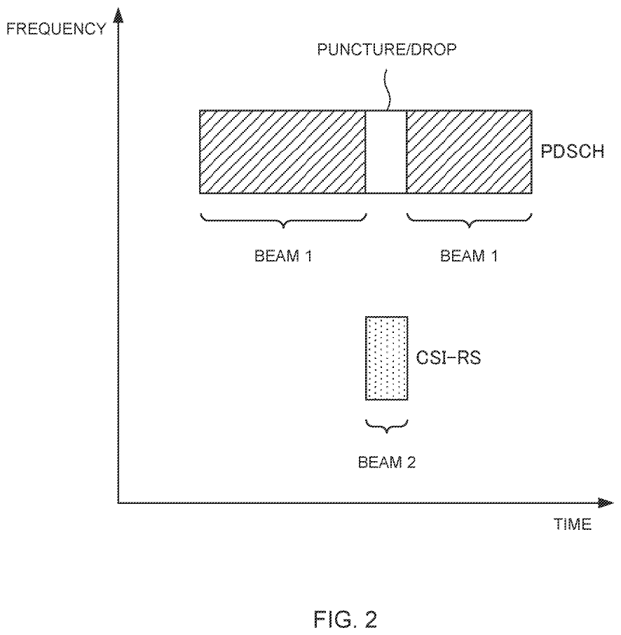

For example, FIG. 2 shows a case in which the CSI-RS overlaps with a part of the symbols of the PDSCH, the RS or QCL type D of the PDSCH corresponds to beam 1, and the RS of QCL type D of the CSI-RS corresponds to beam 2. In this example, the LE receives the PDSCH in the non-overlap symbol by using beam 1. In this example, the UE receives the CSI-RS in the overlap symbol by using beam 2.

### [Reception Processing 2]

In the overlap symbol, the UE may receive the PDSCH by using the RS of QCL type D of the CSI-RS. In the non-overlap symbol, the UE may receive the PDSCH by using the RS of QCL type D of the PDSCH.

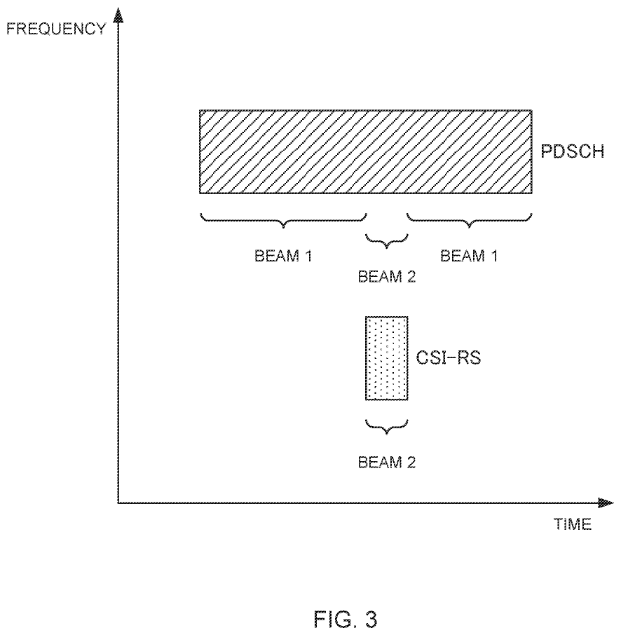

For example, FIG. 3 shows a case in which the CSI-RS overlaps with a part of the symbols of the PDSCH, the RS of QCL type D of the PDSCH corresponds to beam 1, and the RS of QCL type D of the CSI-RS corresponds to beam 2. In this example, the UE receives the PDSCH in the non-overlap symbol by using beam 1, and receives the PDSCH in the overlap symbol by using beam 2. In this example, the UE receives the CSI-RS in the overlap symbol by using beam 2.

### <<Variations>>

### [Determination Based on PDSCH Time Offset]

The UP may determine the reception operation of at least one of the PDSCH and the CSI-RS, based on comparison (large or small) between the time offset (PDSCH time offset) between reception of the DCI for scheduling the PDSCH and the PDSCH and the time length threshold for QCL.

If the PDSCH time offset is less than (smaller than) the time length threshold for QCL, the UP may receive the PDSCH in the overlap symbol by using the RS of QCL type D of the specific DL signal (for example, the CSI-RS) in the overlap symbol.

If the PDSCH time offset is equal to or larger than the time length threshold for QCL, the UP may receive the PDSCH in the overlap symbol by using the TCI state indicated by the DCI for scheduling the PDSCH, or need not receive the CSI-RS in the overlap symbol.

If the PDSCH time offset is equal to or larger than the time length threshold for QCL, the UP may receive the PDSCH in the overlap symbol by using the TCI state indicated by the DCI for scheduling the PDSCH, or may measure the CSI-RS in the overlap symbol by using the TCI state indicated by the DCI for scheduling the PDSCH.

### [Determination Based on A-CSI-RS Time Offset]

When the CSI-RS is the A-CSI-RS, the UE may determine the reception operation of at least one of the PDSCH and the CSI-RS, based on comparison (large or small) between the time offset (A-CSI-RS time offset) between reception of the DCI for scheduling the A-CSI-RS and the A-CSI-RS and the A-CSI-RS beam switch timing threshold.

If the A-CSI-RS time offset is equal to or larger than the A-CSI-RS beam switch timing threshold, the UP may receive the PDSCH in the overlap symbol by using the RS of QCL type D of the A-CSI-RS in the overlap symbol, or may receive the A-CSI-RS in the overlap symbol by using the RS of QCL type P of the A-CSI-RS in the overlap symbol.

If the A-CSI-RS time offset is less than the A-CSI-RS beam switch timing threshold, the UE may receive the A-CSI-RS in the overlap symbol by using the RS of QCL type D of the PDSCH in the overlap symbol, or need not receive the A-CSI-RS in the overlap symbol.

### [Determination Based on Contents of Overlap Symbol of PDSCH]

The UE may determine the reception operation of at least one of the PDSCH and the CSI-RS, based on whether or not the overlap symbol of the PDSCH is data, is a DMRS, or includes a DMRS and data.

When the overlap symbol of the PDSCH is data, the UE need not receive the PDSCH in the overlap symbol, or may receive the PDSCH in the overlap symbol by using the RS of QCL type D of the CSI-RS.

When the overlap symbol of the PDSCH includes a DMRS, the UE may prioritize reception of the PDSCH. In this case, the UE need not measure the CSI-RS in the overlap symbol, or may receive the CSI-RS in the overlap symbol by using the RS of QCL type D of the PDSCH.

### [Beam Switch Time]

Time necessary for beam switch (beam switch time) may be defined. When the UE performs beam switch while receiving the PDSCH, the UE need not be required to receive the PDSCH during the beam switch time.

### [Dropping of All Symbols of PDSCH]

The UE may measure the CSI-RS in the overlap symbol by using the RS of QCL type D of the CSI-RS, and need not receive the PDSCH. The UE may assume that all of the symbols of the PDSCH are punctured or dropped, and need not perform reception, demodulation, or decoding of all of the symbols of the PDSCH.

### [Dropping of Overlap Symbol of PDSCH]

In the symbol (overlap symbol) in which the PDSCH and the CSI-RS overlap each other, the UE may measure the CSI-RS, and need not perform reception (demodulation, decoding) of the PDSCH. The UE may assume that the PDSCH is punctured or dropped in the overlap symbol, and may perform demodulation and decoding of the PDSCH in a symbol (non-overlap symbol) that is not the overlap symbol.

### [PDSCH Reception Operation]

If the PDSCH and the CSI-RS overlap each other in at least one symbol, and the RS of QCL type D of the PDSCH is different from the RS of QCL type D of the CSI-RS, the UE may receive the PDSCH, or may receive at least one of the PDSCH and the CSI-RS by using the RS of QCL type D of the PDSCH.

For example, in the overlap symbol, the UE may receive (demodulate, decode) the PDSCH by using the RS of QCL type D of the PDSCH, and need not measure the CSI-RS. The UE may assume that the CSI-RS is punctured or dropped in the overlap symbol, and may measure the CSI-RS in the non-overlap symbol by using the RS of QCL type D of the CSI-RS.

For example, in the overlap symbol, the UE may measure the CSI-RS by using the RS of QCL type D of the PDSCH. In the non-overlap symbol, the UE may receive the CSI-RS by using the RS of QCL type D of the CSI-RS.

### [Specific DL Signal]

The specific DL signal may be a CSI-RS for the purpose of at least one of tracking (TRS), beam management (CSI-RS for beam management), radio link monitoring (RLM), beam failure detection (BFD), and CSI measurement.

The specific DL signal may be an SSB.

### [Reception of Plurality of DMRSs Using Different Beams]

If the UE performs channel estimation of the DMRS by using the RS of QCL type D of the CSI-RS in the symbol in which the DMRS of the PDSCH and the CSI-RS overlap each other, the phase becomes discontinuous due to switching of QCL (beam), and thus it is difficult to use a plurality of channel estimation results obtained using different RSs of QCL type D for one PDSCH.

The UE need not use the channel estimation results based on the DMRS received by using a given RS of QCL type D for demodulation of the PDSCH received by using a different RS of QCL type D.

The PDSCH may include a plurality of DMRSs (a front-loaded DMRS and an additional DMRS).

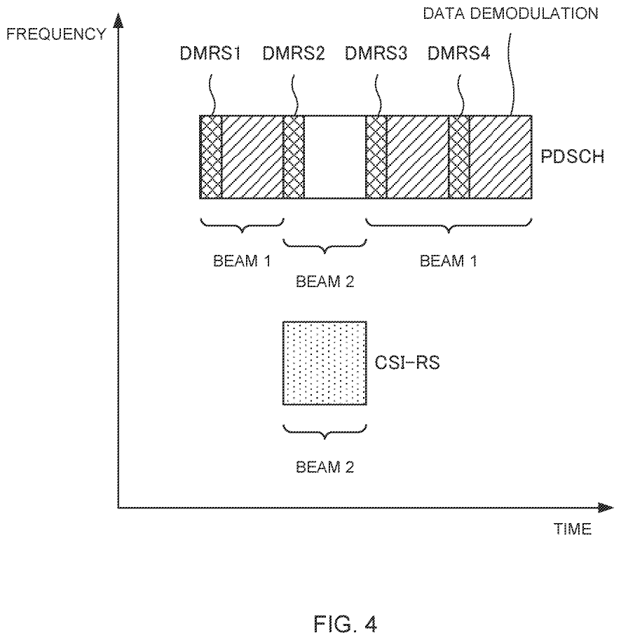

For example, as shown in FIG. 4, the PDSCH and the CSI-RS overlap each other in at least one symbol, the RS of QCL type D of the PDSCH is different from the RS of QCL type P of the CSI-RS, the RS of QCL type D of the PDSCH corresponds to beam 1, and the RS of QCL type D of the CSI-RS corresponds to beam 2. Out of DMRSs 1 to 4 in the PDSCH, DMRS 2 overlaps with the CSI-RS.

In this example, the UE receives DMRSs 1, 3, and 4 in the non-overlap symbol by using beam 1, and performs channel estimation. The UE does not use DMRS 2 in the overlap symbol for demodulation of the PDSCH. The UE may demodulate data in the non-overlap symbol by using the DMRS in the non-overlap symbol. The UE need not demodulate data in the overlap symbol.

The UE may use the channel estimation results based on the DMRS received by using a given RS of QCL type P for demodulation of the PDSCH received by using the same RS of QCL type D.

### [Beam Switch]

It is considered that the RS of QCL type D used for reception of the DMRS and the RS of QCL type U used for reception of the data are different due to beam switch. In this case, continuity of the phase cannot be secured, and demodulation of the data is difficult.

The UE may determine the timing of switching of the beam, based on the symbol of the DMRS.

In a period (overlap period) from the start symbol of the DMRS that is the same as or before the start symbol of the CSI -RS to the symbol immediately before the DMRS that is after the end symbol of the CSI-RS out of the PDSCH overlapping with the CSI-RS, the UE using reception processing 2 described above may use the RS of QCL type D of the PDSCH in symbols other than the above (non-overlap period) by using the RS of QCL type D of the CSI-RS.

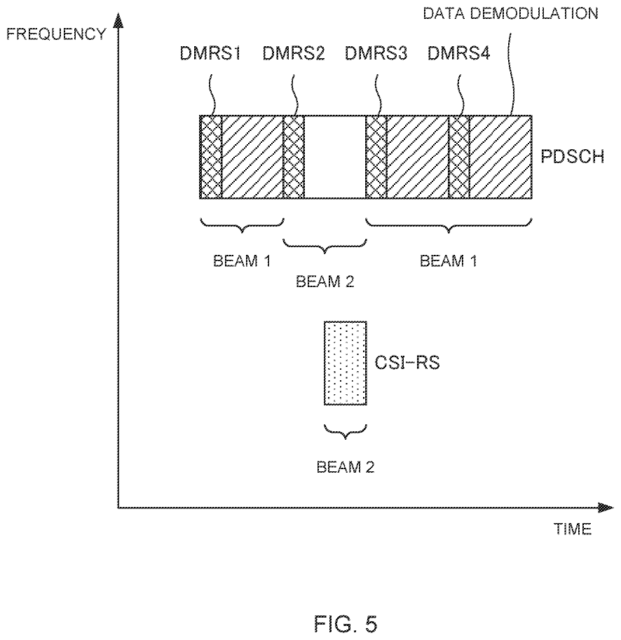

For example, as shown in FIG. 5, the PDSCH and the CSI-RS overlap each other in at least one symbol, the RS of QCL type D of the PDSCH is different from the RS of QCL type D of the CSI-RS, the RS of QCL type D of the PDSCH corresponds to beam 1, and the RS of QCL type D of the CSI-RS corresponds to beam 2. Symbols from the start symbol of DMRS 2 to the symbol immediately before DMRS 3 out of the PDSCH overlap with the CSI-RS.

In this example, the UE regards the symbols from the start symbol of DMRS 2 to the symbol immediately before DMRS 3 as the overlap period, and uses the RS of QCL type D of the PDSCH in the non-overlap period and uses the RS of QCL type D of the CSI-RS in the overlap period. The UE may demodulate the data in the non-overlap period by using the DMRS in the non-overlap period. The UE need not demodulate the data in the overlap period. The UE may demodulate the data in the overlap period by using the DMRS in the overlap period.

The DMRS may be included in each of the overlap period and the non-overlap period. The DMRS may be included in each of the period to which the RS of QCL type D of the PDSCH is applied and the period to which the RS of QCL type D of the CST-RS is applied.

### Second Embodiment

In the target case, the UE may perform rate match of the PDSCH in the symbol (overlap symbol) (around the overlap symbol) in which the PDSCH and the specific DL signal overlap each other.

The specific DL signal may be a CSI-RS. In the target case, the UK may perform rate match of the PDSCH in the symbol (overlap symbol) (around the overlap symbol) in which the PDSCH and the CSI-RS overlap each other.

In this case, the UK may assume that data is not mapped in the overlap symbol out of the PDSCH, and may determine the RS that can be used for the PDSCH.

Provided that the CSI-RS is the A-CSI-RS, when the UE fails in reception of the DCI for triggering the A-CS, the PDSCH may not be able to be decoded. Thus, the CSI-RS according to the second. embodiment may be a P-CSI-RS or an SP-CSI-RS. In contrast, the CSI-RS according to the first embodiment may be an A-CSI-RS.

### [Plurality of Receptions of PDSCH]

A plurality of receptions of the PDSCH (reception occasion, initial transmission and retransmission, or multi-slot PDSCH) may have the same transport block (TB) size, and may use the same resource (RE or RB) in the slot. When at least one reception of the plurality of receptions overlaps with the CSI-RS, the UE may assume that the PDSCH is subjected to rate match, regardless of whether or not each of the receptions overlaps with the CSI-RS.

When the first reception of the PDSCH (the initial transmission of the PDSCH, or the reception of the first slot of the multi-slot PDSCH) overlaps with the CSI-RS, the UE may assume that the PDSCH is subjected to rate match, based on the resource of the CSI-RS.

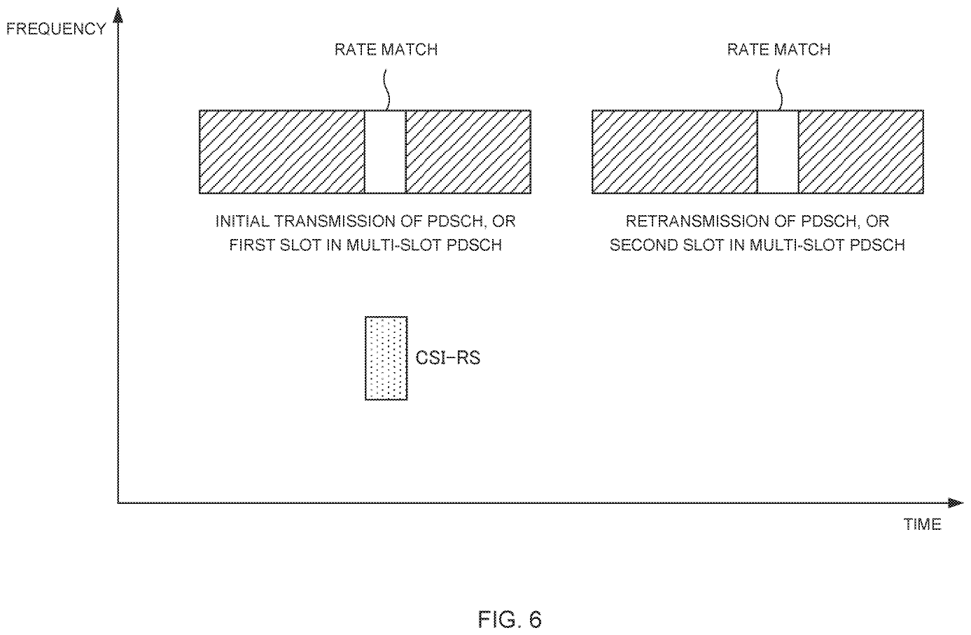

For example, as shown in FIG. 6, when the first reception out of the plurality of receptions of the PDSCH (initial transmission of the PDSCH, or the first slot of the multi-slot PDSCH) overlaps with the CSI-RS, the UE may assume that all of the plurality of receptions are subjected to rate match. For example, the UE may perform rate match of each of the plurality of receptions in the same symbol as the overlap symbol in each of the slots of the plurality of receptions.

The UE need not expect that the following (second and later) receptions of the PDSCH overlap with the CSI-RS having a different RS of QCL type D. The UE may carry out the first embodiment for the following receptions of the PDSCH.

When at least one reception of the plurality of receptions of the multi-slot PDSCH overlaps with the CSI-RS, the UE may assume that the PDSCH is subjected to rate match in all of the receptions. For example, the UE may perform. rate match of all of the receptions of the PDSCH in the resource (RE or RB) overlapping with the CSI-RS of the first reception.

When the first reception of the PDSCH (initial transmission of the PDSCH, or reception of the first slot of the multi-slot PDSCH) does not overlap with the CSI-RS, the UE need not expect that the following receptions of the PDSCH overlap with the CSI-RS, and may carry out the first embodiment for the following receptions of tine PDSCH.

### [A-CSI-RS]

When the A-CSI-RS is triggered after the PDSCH is scheduled, the PDSCH cannot be subjected to rate match. When the CSI-RS is the A-CSI-RS, the UE need not expect that the DCI for triggering the A-CSI-RS comes later than the DCI for scheduling the PDSCH. When the CSI-RS is the A-CSI-RS, for the UE, the DCI for triggering the A-CSI-RS may be the same as the DCI for scheduling the PDSCH.

Performing rate match of the PDSCH in the overlap symbol with the A-CSI-RS makes UE operation complicated. When the DCI for triggering the A-CSI-RS and the DCI for scheduling the PDSCH are present in different CCs, operation equivalent to that of cross carrier scheduling is substantially required.

When the DCI for triggering the A-CSI-RS and the DCI for scheduling the PDSCH are the same, the UE may perform rate match of the PDSCH in the overlap symbol.

When the DCI for triggering the A-CSI-RS and the DCI for scheduling the PDSCH are present in the same CC, the CE may perform rate match of the PDSCH in the overlap symbol.

When the DCI for triggering the A-CSI-RS and the DCI for scheduling the PDSCH are present in different CCs, the UE supporting cross carrier scheduling may perform rate match of the PDSCH in the overlap) symbol. When the DCI for triggering the A-CSI-RS and the DCI for scheduling the PDSCH are present in different CCs, the UE not supporting cross carrier scheduling may perform rate match of the PDSCH in the overlap symbol, need not perform rate match of the PDSCH, or may carry out the first embodiment. The UE need not expect that the DCI for triggering the A-CSI-RS and the DCI for scheduling the PDSCH are present in different CCs.

### [Determination Based on Contents of Overlap Symbol of PDSCH]

Operation related to rate match may be determined based on whether or not the overlap symbol of the PDSCH is data, is a DMRS, or includes a DMRS and data.

When the overlap symbol of the PDSCH is data, the UE may perform rate match of the PDSCH in the overlap symbol. When the overlap symbol of the PDSCH includes a DMRS, the UE need not perform rate match of the PDSCH at least in the symbol of the DMRS. With this, the UE may prioritize reception of the DMRS, and the RS of QCL type D used for the DMRS may be the RS of QCL type D of the PDSCH, or may be the RS of QCL type D of the CSI-RS.

### Third Embodiment

In the target case, the UE may report supporting or in this case assuming of reception of the PDSCH by using UE capability information (parameter).

Subcarriers of the SSB or the CSI-RS may be different from subcarriers of the PDSCH. The UE may report supporting or in this case assuming of reception of the PDSCH as the UE capability information in a specific case when the subcarriers of the SSB or the CSI-RS are the same as the subcarriers of the PDSCH. The UE may report supporting or in this case assuming of reception of the PDSCH as the UE capability information in a specific case when the subcarriers of the SSB or the CSI-RS are different from the subcarriers of the PDSCH.

The UE may report a maximum number of DL signals that can be simultaneously received using different RSs of QCL type D as the UE capability information. The maximum number depends on a panel configuration of the UE, and the UE may report the number of panels of the UE as the UE capability information. The DL signal may be a DL channel (for example, a PDSCH, or a PDCCH), or may be a DL-RS (for example, a CSI-RS, an SSB, or a TRS).

It may be considered that the UE can simultaneously receive as many DL signals as up to the number of panels by using different RSs of QCL type D.

### Fourth Embodiment

In contrast to example 1 described above, the UE of Rel. 15 NR is required to follow (track) only the active TCI state. The UE is not required to track (or measure, or receive, or monitor, or detect) the TRS configured for a non-active TCI state (TCI state that is not activated).

The specific DL signal may be a TRS. A TRS, a CSI-RS for tracking, a CSI-RS having TRS information (higher layer parameter trs-Info), and NZP-CSI-RS resources in an NZP-CSI-RS resource set having the TRS information may be interchangeably interpreted as each other.

The target case may be a case in which the TRS configured to the non-active TCI state overlaps with the PDSCH in at least one symbol, and the RS of QCL type D of the PDSCH is different from the RS of QCL type D of the TRS.

In the target case, at least one of the following TRS processing's 1 and 2 may be defined.

### [TRS Processing 1]

The UE may ignore the TRS resource, and the PDSCH may be scheduled in the same symbol as the TRS resource.

### [TRS Processing 2]

The TRS corresponding to the non-active TCI state may be regarded as a normal CSI-RS (not for tracking), regardless of whether or not the UE tracks the TRS.

The target case may be a case in which the PDSCH and the CSI-RS having trs-Info overlap each other in at least one symbol, and the PS of QCL type D of the PDSCH is different from the RS of CCL type D of the CSI-RS.

The target case may be a case in which the PDSCH time offset is equal to or larger than the time length threshold for QCL, the PDSCH and the CSI-RS having trs-Info overlap each other in at least one symbol, and the RS of QCL type D of the PDSCH is different from the RS of QCL type D of the CSI-RS.

The target case may be a case in which the PDSCH and the CSI-RS overlap each other in at least one symbol, and the RS of QCL type D of the PDSCH is different from the RS of QCL type D of the CSI-RS.

The target case may be a case in which the PDSCH time offset is equal to or larger than the time length threshold for QCL, the PDSCH and the CSI-RS overlap each other in at least one symbol, and the RS of QCL type D of the PDSCH is different from the RS of QCL type D of the CSI-RS.

The target case may be a case in which the PDSCH and the CSI-RS having trs-Info or not having trs-Info overlap each other in at least one symbol, and the RS of QCL type D of the PDSCH is different from the RS of QCL type D of the CSI-RS.

The target case may be a case in which the PDSCH time offset is equal to or larger than the time length threshold for QCL, the PDSCH and the CSI-RS having trs-Info or not having trs-Info overlap each other in at least one symbol, and the RS of QCL type D of the PDSCH is different from the RS of QCL type D of the CSI-RS.

### (Radio Communication System)

Hereinafter, a structure of a radio commination system according to one embodiment of the present disclosure will be described. In this radio communication system, the radio communication method according to each embodiment of the present disclosure described above may be used alone or may be used in combination for communication.

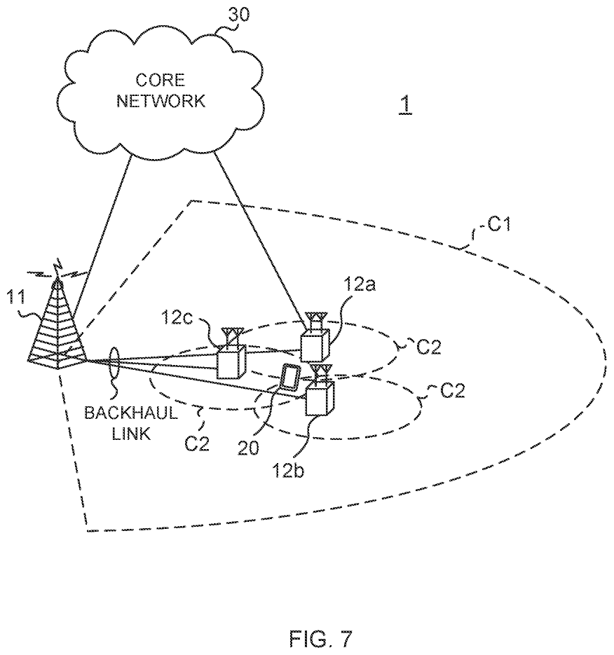

FIG. 7 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency hand (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 Hz). Note that frequency bands, definitions and so on of FR1 and FR2 are by no means limited to these, and for example, FR1 may correspond to a frequency band. which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (CL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. The or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

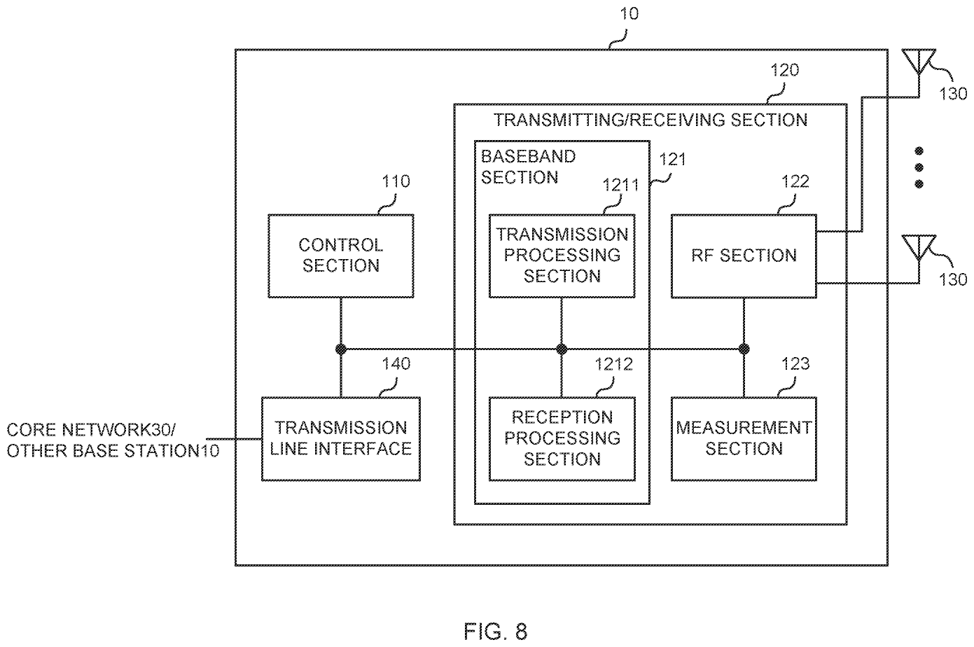

FIG. 8 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting(receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

### (User Terminal)

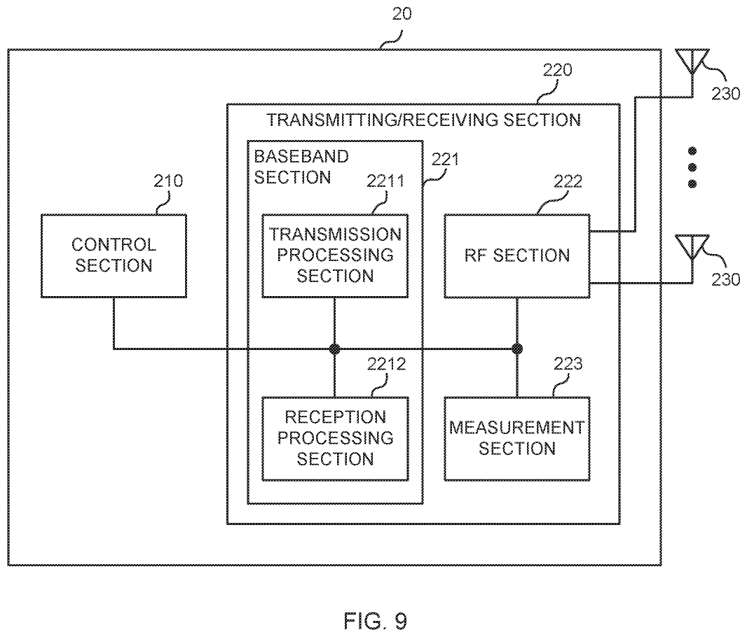

FIG. 9 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/ receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing(as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

When a physical downlink shared channel (PDSCH) and a specific downlink signal overlap each other in at least one symbol, and a first reference signal of quasi-co-location (QCL) type D of the PDSCH is different from a second reference signal of the QCL type D of the specific downlink signal, the transmitting/receiving section 220 may receive a signal of at least one of the PDSCH and the specific downlink signal by using the second reference signal in the at least one symbol. The control section 210 may perform at least one of decoding and measurement of the received signal.

The control section 210 may perform measurement of the specific downlink signal, may not decode the at least one symbol of the PDSCH, and may decode a symbol other than the at least one symbol of the PDSCH (first embodiment/reception processing 1).

The control section 210 may decode the at least one symbol of the PDSCH. The transmitting/receiving section 220 may receive a symbol other than the at least one symbol of the PDSCH by using the first reference signal. The control section 210 may decode the symbol other than the at least one symbol of the PDSCH (first embodiment/reception processing 2).

The control section 210 may perform rate match of the PDSCH in the at least one symbol (second embodiment).

When the PDSCH and the specific downlink signal overlap each other in the at least one symbol, and the first reference signal of the QCL type D of the PDSCH is different from the second reference signal of the QCL type D of the specific downlink signal, the control section 210 may report capability information indicating whether or not the PDSCH can be received (third embodiment).

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

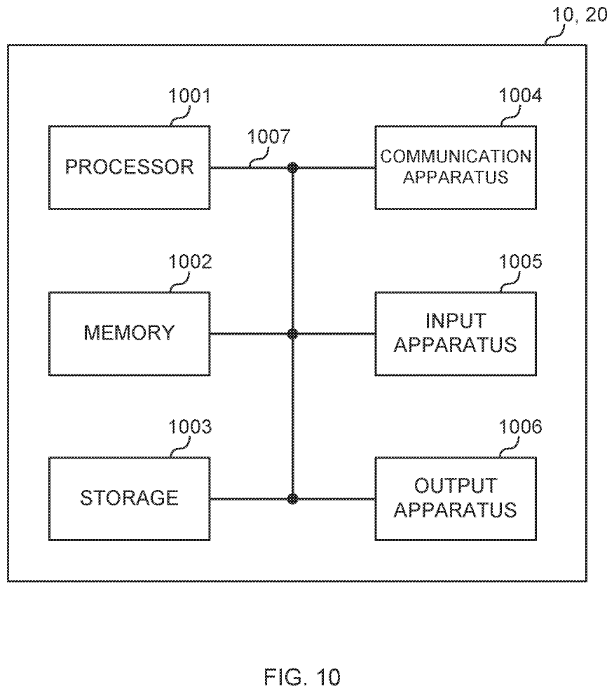

For example, a base station, a user terminal, and so on according to one embodiment of the present disclosure may function as a computer that executes the processes of the radio communication method of the present disclosure. FIG. 10 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 maybe formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mind-slot may be constituted of one or a plurality of symbols in the time domain. A mini-slot may be referred to as a “sub-slot.” A mini-slot may be constituted of symbols less than the number of slots. A PDSCH (or PUSCH transmitted in a time unit larger than a mini-slot maybe referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mind-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mind-slot maybe referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal)) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. TTI that is shorter than a normal TTI may be referred to as a “shortened TTI,” a “short TTI,” a “partial or fractional TTI,” a “shortened subframe,” a “short subframe,” a “mini-slot,” a “sub-slot” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified spy given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety or different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be notified using, for example, MAC control elements (MAC CEs).

Also, notification of given information (for example, notification of “X holds”) does not necessarily have to be notified explicitly, and can be notified implicitly (by, for example, not performing notification of this given information or notification of another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pica cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station, ” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Thing's (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so or that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, INT-Advanced, 4th generation mobile communication system (4G), 5th generation mobile communication system (5G), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging(determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and is various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section configured to, when a physical downlink shared channel (PDSCH) and a specific downlink signal overlap each other in at least one symbol, and a first reference signal of quasi-co-location (QCL) type D of the PDSCH is different from a second reference signal of the QCL type D of the specific downlink signal, receive a signal of at least one of the PDSCH and the specific downlink signal by using the second reference signal in the at least one symbol; and
a control section configured to perform at least one of decoding and measurement of the received signal.

2. The terminal according to claim 1, wherein the control section performs measurement of the specific downlink signal, does not decode the at least one symbol of the PDSCH, and decodes a symbol other than the at least one symbol of the PDSCH.

3. The terminal according to claim 1, wherein the control section decodes the at least one symbol of the PDSCH, the receiving section receives a symbol other than the at least one symbol of the PDSCH by using the first reference signal, and the control section decodes the symbol other than the at least one symbol of the PDSCH.

4. The terminal according to claim 1, wherein the control section performs rate match of the PDSCH in the at least one symbol.

5. The terminal according to claim 1, wherein when the PDSCH and the specific downlink signal overlap each other in the at least one symbol, and the first reference signal of the QCL type D of the PDSCH is different from the second reference signal of the QCL type D of the specific downlink signal, the control section reports capability information indicating whether or not the PDSCH can be received.

6. A radio communication method for a terminal, the method comprising:
when a physical downlink shared channel (PDSCH) and a specific downlink signal overlap each other in at least one symbol, and a first reference signal of quasi-co-location (QCL) type D of the PDSCH is different from a second reference signal of the QCL type D of the specific downlink signal, receiving a signal of at least one of the PDSCH and the specific downlink signal by using the second reference signal in the at least one symbol; and
performing at least one of decoding and measurement of the received signal.

7. The terminal according to claim 2, wherein the control section performs rate match of the PDSCH in the at least one symbol.

8. The terminal according to claim 2, wherein when the PDSCH and the specific downlink signal overlap each other in the at least one symbol, and the first reference signal of the QCL type D of the PDSCH is different from the second reference signal of the QCL type D of the specific downlink signal, the control section reports capability information indicating whether or not the PDSCH can be received.

9. The terminal according to claim 3, wherein when the PDSCH and the specific downlink signal overlap each other in the at least one symbol, and the first reference signal of the QCL type D of the PDSCH is different from the second reference signal of the QCL type D of the specific downlink signal, the control section reports capability information indicating whether or not the PDSCH can be received.

10. The terminal according to claim 4, wherein when the PDSCH and the specific downlink signal overlap each other in the at least one symbol, and the first reference signal of the QCL type D of the PDSCH is different from the second reference signal of the QCL type D of the specific downlink signal, the control section reports capability information indicating whether or not the PDSCH can be received.
